(19) United States
(12) Patent Application Publication
(10) Pub. No.: US 2024/0169225 A1
(43) Pub. Date: May 23, 2024

(54) METHOD AND APPARATUS FOR CREATING A MACHINE LEARNING SYSTEM

(71) Applicant: Robert Bosch GmbH, Stuttgart (DE)

(72) Inventors: Benedikt Sebastian Staffler, Tuebingen (DE); Jan Hendrik Metzen, Boeblingen (DE)

(21) Appl. No.: 18/549,055

(22) PCT Filed: Jul. 22, 2022
(86) PCT No.: PCT/EP2022/070591

§ 371 Date: Sep. 5, 2023

(30) Foreign Application Priority Data
Jul. 29, 2021 (DE) 10 2021 208 197.5

(51) Int. Cl. G06N 7/01

(52) U.S. Cl. CPC G06N 7/01

(57) ABSTRACT

Method for creating a machine learning system. The method includes: providing a directed graph with an input node and output node, wherein each edge is assigned a probability which characterizes with which probability an edge is drawn. The probabilities are ascertained depending on a coding of the currently drawn edges.

### FIELD

The present invention relates to a method for creating a machine learning system using a graph describing a plurality of possible architectures of the machine learning system, a computer program, and a machine-readable storage medium.

### BACKGROUND INFORMATION

The goal of an architecture search, especially for neural networks, is to find the best possible network architecture in terms of a performance metric/ratio for a given data set in a fully automated way.

To make automatic architecture search computationally efficient, different architectures in the search space can share the weights of their operations, such as in a one-shot NAS model shown by Pham, H., Guan, M. Y., Zoph, B., Le, Q. V., & Dean, J. (2018), “Efficient neural architecture search via parameter sharing;” arXiv preprint arXiv:1802.03268.

Here, the one-shot model is typically constructed as a directed graph where the nodes represent data and the edges operations, which represent a calculation rule, which transform the input node data into output node data. The search space consists of subgraphs (e.g. paths) in the one-shot model. Since the one-shot model can be very large, individual architectures can be pulled from the one-shot model for training, such as shown by Cai, H., Zhu, L., & Han, S. (2018); “ProxylessNAS: Direct neural architecture search on target task and hardware;” arXiv preprint arXiv:1812.00332. This is typically done in that a single path is drawn from a specified input node to an output node of the network, as shown for example by Guo, Z., Zhang, X., Mu, H., Heng, W., Liu, Z., Wei, Y., & Sun, J. (2019); “Single path one-shot neural architecture search with uniform sampling;” arXiv preprint arXiv:1904.00420.

Authors Cai et al. describe in their paper “ProxylessNAS: Direct Neural Architecture Search on Target Task and Hardware;” available online: https://arxiv.org/abs/1812.00332, an architecture search that considers hardware characteristics.

### SUMMARY

As described above, paths are drawn (i.e., selected or sampled) between input nodes and output nodes from a one-shot model. For this purpose, a probability distribution over the outgoing edges is defined for each node. The inventors propose a novel parameterization of the probability distribution that is more informative than the previously used probability distributions with respect to dependencies between edges that have already been drawn. The purpose of this novel parameterization is to incorporate dependencies between different decision points in the search space into the probability distributions. For example, such a decision may be the selection of a neural network operation (such as decisions between convolutional and pooling operations). This can be used, for example, to learn general patterns such as “two convolutional layers should be followed by a pooling operation”. Previous probability distributions could only learn simple decision rules, such as “a particular convolution should be chosen at a particular decision point”, because they used a fully factorized parametrization of the architectural distribution.

So, in summary, the present invention has the advantage of finding better architectures for a given task via the proposed parameterization of the probability distributions.

In a first aspect, the present invention relates to a computer-implemented method for creating a machine learning system, preferably used for image processing.

According to an example embodiment of the present invention, the method comprises at least the following steps: Providing a directed graph with at least one input node and output node connected by a plurality of edges and nodes. The graph, in particular the one-shot model, describes a supermodel comprising a plurality of possible architectures of the machine learning system.

This is followed by a random drawing (i.e., selection or sampling) of a plurality of paths through the directed graph, in particular of subgraphs of the directed graph, where the edges are each assigned a probability which characterizes with which probability the respective edge is drawn. The special feature here is that the probabilities are ascertained depending on a sequence of previously drawn edges of the respective path. Thus, the probabilities of the possible subsequent edges to be drawn are ascertained depending on a section of the path drawn so far through the directed graph. The previously drawn section can be called a subpath and can have the previously drawn edges, it being possible iteratively to add subsequently drawn edges until the input node is connected to the output node, i.e., the drawn path then being available. Preferably, the probabilities are also ascertained depending on the operations assigned to the respective edges.

It should be noted that drawing the path can be done iteratively. Thus, a step-by-step creation of the path is done by successively drawing the edges, wherein at each reached node of the path the subsequent edge can be randomly selected from the possible subsequent edges connected to this node depending on their assigned probabilities.

Further note that a path can be understood as a subgraph of the directed graph having a subset of the edges and nodes of the directed graph, where this subgraph connects the input node to the output node of the directed graph.

Subsequently, according to an example embodiment of the present invention, the machine learning systems corresponding to the drawn paths are trained, wherein parameters of the machine learning system and, in particular, the probabilities of the edges of the path are adjusted during training so that a cost function is optimized.

This is followed by a final drawing of a path depending on the adjusted probabilities and creation of the machine learning system corresponding to this path. The last drawing of the path in the last step can be done randomly or the edges with the highest probabilities are drawn specifically.

According to an example embodiment of the present invention, it is proposed that a function ascertains the probabilities of the edges depending on the order of the edges drawn so far, where the function is parameterized and the parameterization of the function is optimized during training depending on the cost function. Preferably, each edge is assigned its own function, which ascertains a probability depending on the sequence of the previously drawn edges of the partial path.

According to an example embodiment of the present invention, it is further proposed that a unique coding is assigned to the edges and/or nodes drawn so far and that the function ascertains the probability depending on this coding. Preferably, a unique index is assigned to each edge for this purpose.

According to an example embodiment of the present invention, it is further proposed that the function ascertains a probability distribution over the possible edges, from a set of edges that can be drawn next. Particularly preferably, each node is assigned its own function, wherein the functions ascertain the probability distribution over all edges connecting the respective node with immediate subsequent neighboring nodes of the graph.

According to an example embodiment of the present invention, it is further proposed that the function is an affine transformation or a neural network (such as a transformer).

According to an example embodiment of the present invention, it is further proposed that the parameterization of the affine transformation describes a linear transformation and a shift in the unique coding. To make the linear transformation more parameter efficient, the linear transformation can be a so-called low-rank approximation of the linear transformation.

According to an example embodiment of the present invention, it is further proposed that each node is assigned a neural network for ascertaining the probabilities and that a parameterization of the first layers of the neural networks can be shared among all neural networks. Particularly preferably, the neural networks share all but the parameters of the last layer.

Furthermore, according to an example embodiment of the present invention, it is proposed that the cost function comprises a first function that evaluates a capability of the machine learning system with regard to its performance, for example, comprising an accuracy of segmentation, object recognition, or the like and, optionally, a second function that estimates a latency period of the machine learning system depending on a length of the path and the operations of the edges. Alternatively or additionally, the second function may also estimate a computer resource consumption of the path.

Preferably, the machine learning system created is an artificial neural network, which may be set up for segmentation and object detection in images.

According to an example embodiment of the present invention, it is further proposed that a technical system is controlled as a function of an output of the machine learning system. Examples of the technical system are shown in the following figure description.

In further aspects, the present invention relates to a computer program designed to perform the above methods and to a machine-readable storage medium on which said computer program is stored.

Example embodiments of the present invention are explained in greater detail below with reference to the figures.

### BRIEF DESCRIPTION OF THE DRAWINGS

FIG. 1 shows a schematic diagram of a flow chart of an example embodiment of the present invention.

FIG. 2 shows a schematic representation of an actuator control system, according to an example embodiment of the present invention.

FIG. 3 shows an exemplary embodiment for controlling an at least partially autonomous robot, according to the present invention.

FIG. 4 schematically shows an exemplary embodiment for controlling a manufacturing system, according to the present invention.

FIG. 5 schematically shows an exemplary embodiment for controlling an access system, according to the present invention.

FIG. 6 schematically shows an exemplary embodiment for controlling a monitoring system, according to the present invention.

FIG. 7 schematically shows an exemplary embodiment for controlling a personal assistant, according to the present invention.

FIG. 8 schematically shows an exemplary embodiment for controlling a medical imaging system, according to the present invention.

FIG. 9 shows a possible structure of a training apparatus, according to an example embodiment of the present invention.

### DETAILED DESCRIPTION OF EXAMPLE EMBODIMENTS

To find good deep neural network architectures for a given data set, automatic architecture search methods can be applied, so-called neural architecture search methods. For this purpose, a search space of possible neural network architectures is defined explicitly or implicitly.

In the following, a calculation graph (the so-called one-shot model) will be defined to describe a search space, which contains a plurality of possible architectures in the search space as subgraphs. Since the one-shot model can be very large, individual architectures can be drawn (i.e., selected or sampled) from the one-shot model for training. This is typically done by drawing (i.e., selecting or sampling) individual paths from a specified input node to a specified output node of the network.

In the simplest case, when the calculation graph consists of a chain of nodes, each of which can be connected by different operations, it is sufficient to draw for each two consecutive nodes the operation that connects them.

If the one-shot model is more generally a directed graph, a path can be drawn iteratively, starting at the input, then drawing the next node and the connecting edge, continuing this procedure iteratively until the destination node.

The one-shot model with drawing can then be trained by drawing an architecture for each mini-batch and adjusting the weights of the operations in the drawn architecture using a standard gradient step method. Finding the best architecture can either take place as a separate step after training the weights, or alternate with training the weights.

Formalistically, the one-shot model can be referred to as a so-called supergraph S=(V_{S}, E_{S}). Here, each edge E of this supergraph S of a network operation, such as a convolution, and each node V may be assigned a data tensor representing inputs and outputs of operations. It is also possible that the nodes of the supergraph correspond to a particular neural network operation such as a convolution and each edge corresponds to a data tensor. The goal of the architecture search is to identify some paths G=(V_{G}, E_{G})≤S that optimize one or more performance criteria such as accuracy on a test set and/or latency on a target device.

The drawing of the path explained above can be defined formalistically as follows. Nodes v∈Vᵢ≤V_{S} and/or edges e∈Eⱼ≤E_{S} are iteratively drawn, which together form the path G.

Drawing the nodes/edges can be performed depending on probability distributions, especially categorical distributions. Here, the probability distribution p_{α}_{ᵢ}(v ∈ Vᵢ) and/or p_{α}_{ⱼ}(e ∈Eⱼ) may depend on an optimizable parameter α, wherein the probability distributions have the same cardinality as Vᵢ or Eⱼ.

This iterative drawing of edges/nodes results in a sequence of subpaths G₀, G₁, . . . , Gₖ . . . , G_{T}, wherein G_{T} is the ‘final’ path that connects the input to the output of the graph.

A major limitation of defining the probability distribution by categorical distributions is that these probability distributions p_{αi}(v ∈ Vᵢ) and p_{α}_{ⱼ}(e ∈Eⱼ) are independent of the current drawn path Gₖ. This does not allow learning, especially more complex, dependencies between different nodes and edges. Therefore, it is proposed to formulate the probability distributions depending on the path Gₖ drawn so far: p_{αi}(v ∈ Vᵢ|Gₖ) and p_{α}_{ⱼ}(e ∈ Eⱼ|Gₖ).

More precisely, a unique coding of the previously drawn subpaths Gₖ is proposed. Preferably, a unique index is assigned to each v∈V_{S} and each e∈E_{S} for this purpose, which is referred to as n(v) and n(e) in the following. The unique coding of Gₖ is then h=H(Gₖ) with hᵢ=∃e∈E_{K}n(e)=i or ∃v∈V_{K}n(v)=i.

Given this unique coding, p_{α}_{ᵢ}(v ∈ Vᵢ|Gₖ) (and accordingly p_{α}_{ⱼ}(e∈Eⱼ|Gₖ)) the probabilities can then be ascertained by a function ƒ: p_{α}_{ⱼ}(e∈Eⱼ|Gₖ)=ƒ_{α}_{ⱼ} (H(Gₖ)). The outputs of this function are further used as probabilities for e.g. a categorical distribution from which the node/edge is sampled. However, the probabilities now depend on Gₖ.

The following embodiments of the function ƒ_{αj} are possible: In the simplest case, the function ƒ_{αj} is an affine transformation, e.g. ƒ_{αj}(h)=Wⱼh+bⱼ. In this case αⱼ corresponds to the parameters Wⱼ and bⱼ of the affine transformation. A linear parameterization with fewer parameters can be achieved by a low-rank approximation Wⱼ=W′ⱼWⱼ″. Furthermore, W′ⱼ can be shared across all j and thus act as a low-dimensional (non-unique) coding based on the unique coding h.

A more expressive choice is an implementation of the function ƒ_{αj} by a multi-layer perceptron (MLP), wherein αⱼ represents a parameter of the MLP. Here, too, the parameters of the MLP can optionally be shared across j except for the last layer.

A transformer-based implementation of the function ƒ_{αj} can also be used, consisting of a plurality of layers with ‘multi-headed self-attention’ and a final linear layer. Parameters from all but the last layer can optionally be shared across all j.

The optimization of the parameters of the function can be done by a gradient descent method. Alternatively, the gradients for this can be estimated via a black-box optimizer, e.g. using the REINFORCE trick (see for example the literature “ProxylessNAS” cited above). That is, the optimization of the architecture can be performed in the same way as when using conventional categorical probability distributions.

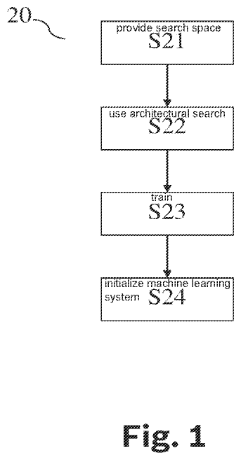

FIG. 1 schematically shows a flowchart (20) of the improved method for architecture search with a one-shot model.

The automatic architecture search can be performed as follows. The automatic architecture search first needs a provision of a search space (S21), which can be given here in the form of a one-shot model.

Subsequently, any form of architectural search that draws paths from a one-shot model can be used (S22). The paths drawn here are drawn depending on a result of the function p_{α}_{ᵢ}(v ∈ Vᵢ|Gₖ) and/or p_{α}_{ⱼ}(e∈Eⱼ|Gₖ).

In the subsequent step (S23), the drawn machine learning systems corresponding to the paths are then trained and the parameters a; of the function are also adjusted during training.

It should be noted that optimization of parameters during training can happen not only in terms of accuracy, but also for special hardware (e.g. hardware accelerators). For example, in that in training, the cost function includes another term that characterizes the costs of running the machine learning system with its configuration on the hardware.

Steps S22 to S23 can be repeated several times in succession. Then, based on the supergraph, a final path can be drawn (S24) and a corresponding machine learning system can be initialized according to this path.

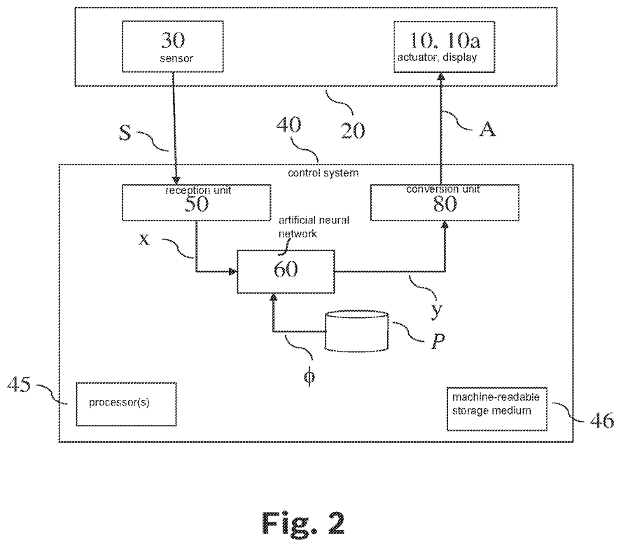

Preferably, the created machine learning system after step S24 is an artificial neural network 60 (illustrated in FIG. 2) and is used as explained below.

FIG. 2 shows an actuator 10 in its environment 20 in interaction with a control system 40. At preferably regular intervals, the environment 20 is sensed by means of a sensor 30, in particular an imaging sensor, such as a video sensor, which may also be given by a plurality of sensors, e.g., a stereo camera. Other imaging sensors are also possible, such as radar, ultrasound, or lidar. A thermal imaging camera is also possible. The sensor signal S, or one sensor signal S each in the case of several sensors, of the sensor 30 is transmitted to the control system 40. The control system 40 thus receives a sequence of sensor signals S. The control system 40 ascertains therefrom control signals A, which are transmitted to the actuator 10.

The control system 40 receives the sequence of sensor signals S of the sensor 30 in an optional reception unit 50, which converts the sequence of sensor signals S into a sequence of input images x (alternatively, the sensor signal S can also respectively be directly adopted as an input image x). For example, the input image x may be a section or a further processing of the sensor signal S. The input image x comprises individual frames of a video recording. In other words, input image x is ascertained as a function of sensor signal S. The sequence of input images x is supplied to a machine learning system, an artificial neural network 60 in the exemplary embodiment.

The artificial neural network 60 is preferably parameterized by parameters ϕ stored in and provided by a parameter memory P.

The artificial neural network 60 ascertains output variables y from the input images x. These output variables y may in particular comprise classification and semantic segmentation of the input images x. Output variables y are supplied to an optional conversion unit 80, which therefrom ascertains control signals A, which are supplied to the actuator 10 in order to control the actuator 10 accordingly. Output variable y comprises information about objects that were sensed by the sensor 30.

The actuator 10 receives the control signals A, is controlled accordingly and carries out a respective action. The actuator 10 can comprise a (not necessarily structurally integrated) control logic which, from the control signal A, ascertains a second control signal that is then used to control the actuator 10.

In further embodiments, the control system 40 comprises the sensor 30. In still further embodiments, the control system 40 alternatively or additionally also comprises the actuator 10.

In further preferred embodiments, the control system 40 comprises a single or a plurality of processors 45 and at least one machine-readable storage medium 46 in which instructions are stored that, when executed on the processors 45, cause the control system 40 to carry out the method according to the present invention.

In alternative embodiments, a display unit 10a is provided as an alternative or in addition to the actuator 10.

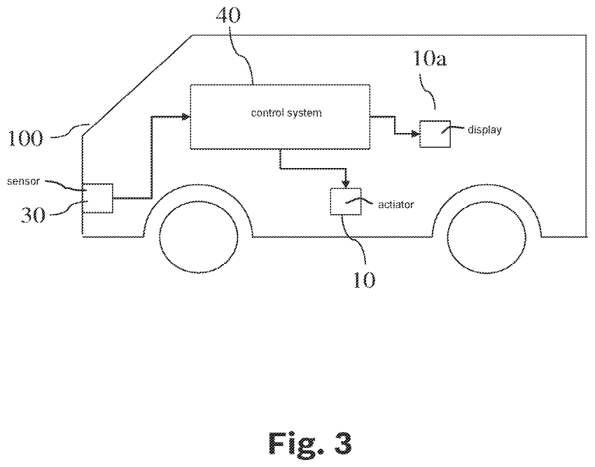

FIG. 3 shows how the control system 40 can be used to control an at least partially autonomous robot, here an at least partially autonomous motor vehicle 100.

The sensor 30 may, for example, be a video sensor preferably arranged in the motor vehicle 100.

The artificial neural network 60 is set up to reliably identify objects x from the input images.

The actuator 10, preferably arranged in the motor vehicle 100, may, for example, be a brake, a drive, or a steering of the motor vehicle 100. The control signal A may then be ascertained in such a way that the actuator or actuators 10 is controlled in such a way that, for example, the motor vehicle 100 prevents a collision with the objects reliably identified by the artificial neural network 60, in particular if they are objects of specific classes, e.g., pedestrians.

Alternatively, the at least semiautonomous robot may also be another mobile robot (not shown), e.g., one that moves by flying, swimming, diving, or walking. For example, the mobile robot may also be an at least semiautonomous lawnmower or an at least semiautonomous cleaning robot. Even in these cases, the control signal A can be ascertained in such a way that drive and/or steering of the mobile robot are controlled in such a way that the at least semiautonomous robot, for example, prevents a collision with objects identified by the artificial neural network 60.

Alternatively or additionally, the control signal A can be used to control the display unit 10a and, for example, to display the ascertained safe areas. It is also possible, for example, in the case of a motor vehicle 100 with non-automated steering, for the display unit 10a to be controlled by the control signal A in such a way that it outputs a visual or audible warning signal if it is ascertained that the motor vehicle 100 is threatening to collide with one of the reliably identified objects.

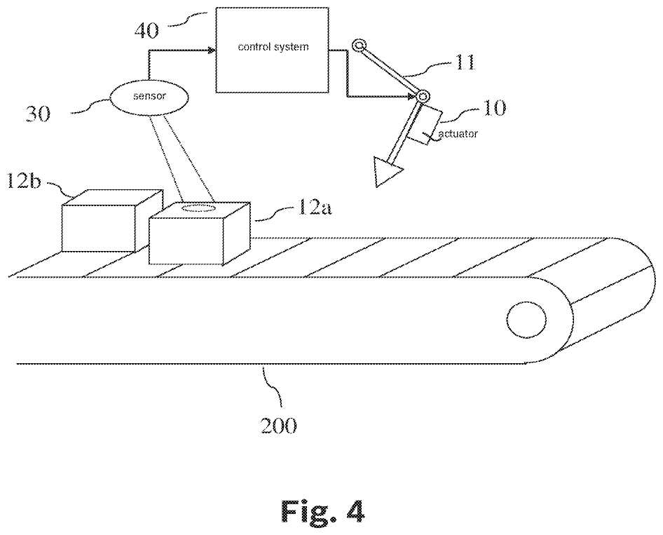

FIG. 4 shows an exemplary embodiment in which the control system 40 is used to control a manufacturing machine 11 of a manufacturing system 200 by controlling an actuator 10 controlling said manufacturing machine 11. The manufacturing machine 11 can, for instance, be a machine for punching, sawing, drilling and/or cutting.

The sensor 30 may then, for example, be an optical sensor that, for example, senses properties of manufacturing products 12a, 12b. It is possible that these manufacturing products 12a, 12b are movable. It is possible that the actuator 10 controlling the manufacturing machine 11 is controlled depending on an assignment of the sensed manufacturing products 12a, 12b so that the manufacturing machine 11 carries out a subsequent machining step of the correct one of the manufacturing products 12a, 12b accordingly. It is also possible that, by identifying the correct properties of the same one of the manufacturing products 12a, 12b (i.e., without misassignment), the manufacturing machine 11 accordingly adjusts the same production step for machining a subsequent manufacturing product.

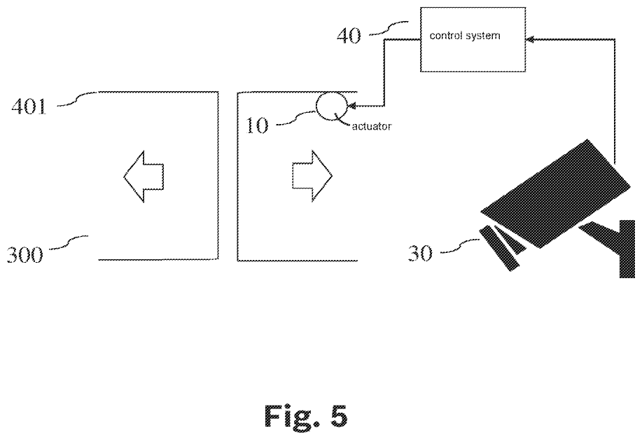

FIG. 5 shows an exemplary embodiment in which the control system 40 is used to control an access system 300. The access system 300 may comprise a physical access control, e.g., a door 401. Video sensor 30 is configured to sense a person. By means of the object identification system 60, this captured image can be interpreted. If several persons are sensed simultaneously, the identity of the persons can be ascertained particularly reliably by associating the persons (i.e., the objects) with one another, e.g., by analyzing their movements. The actuator 10 may be a lock that, depending on the control signal A, releases the access control, or not, for example, opens the door 401, or not. For this purpose, the control signal A may be selected depending on the interpretation of the object identification system 60, e.g., depending on the ascertained identity of the person. A logical access control may also be provided instead of the physical access control.

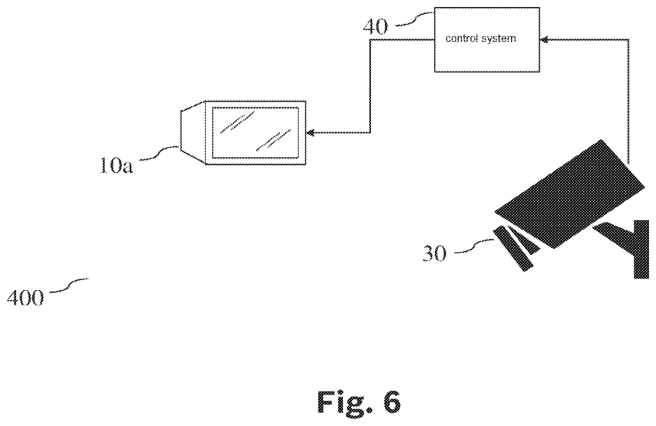

FIG. 6 shows an exemplary embodiment in which the control system 40 is used to control a monitoring system 400. This exemplary embodiment differs from the exemplary embodiment shown in FIG. 5 in that instead of the actuator 10, the display unit 10a is provided, which is controlled by the control system 40. For example, the artificial neural network 60 can reliably ascertain an identity of the objects captured by the video sensor 30, in order to, for example, infer depending thereon which of them are suspicious, and the control signal A can then be selected in such a way that this object is shown highlighted in color by the display unit 10a.

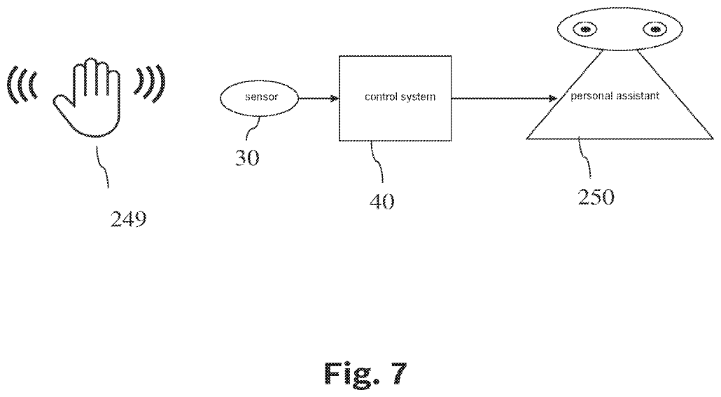

FIG. 7 shows an exemplary embodiment in which the control system 40 is used to control a personal assistant 250. The sensor 30 is preferably an optical sensor that receives images of a gesture of a user 249.

Depending on the signals of the sensor 30, the control system 40 ascertains a control signal A of the personal assistant 250, e.g., by the neural network performing gesture recognition. This ascertained control signal A is then transmitted to the personal assistant 250 and the latter is thus controlled accordingly. This ascertained control signal A may in particular be selected to correspond to a presumed desired control by the user 249. This presumed desired control can be ascertained depending on the gesture recognized by the artificial neural network 60. Depending on the presumed desired control, the control system 40 can then select the control signal A for transmission to the personal assistant 250 and/or select the control signal A for transmission to the personal assistant according to the presumed desired control 250.

This corresponding control may, for example, include the personal assistant 250 retrieving information from a database and rendering in such a way that it can be received by the user 249.

Instead of the personal assistant 250, a domestic appliance (not shown) may also be provided, in particular a washing machine, a stove, an oven, a microwave or a dishwasher, in order to be controlled accordingly.

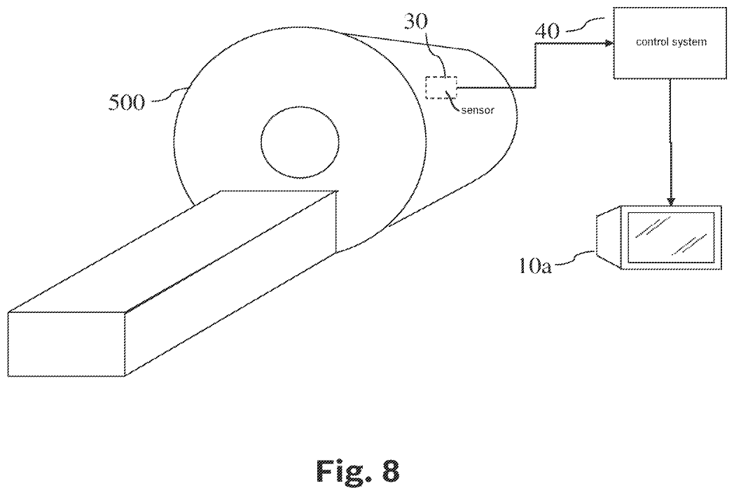

FIG. 8 shows an exemplary embodiment in which the control system 40 is used to control a medical imaging system 500, e.g., an MRT, X-ray, or ultrasound device. For example, the sensor 30 may be given by an imaging sensor, and the display unit 10a is controlled by the control system 40. For example, the neural network 60 may ascertain whether an area captured by the imaging sensor is abnormal, and the control signal A may then be selected in such a way that this area is presented highlighted in color by the display unit 10a.

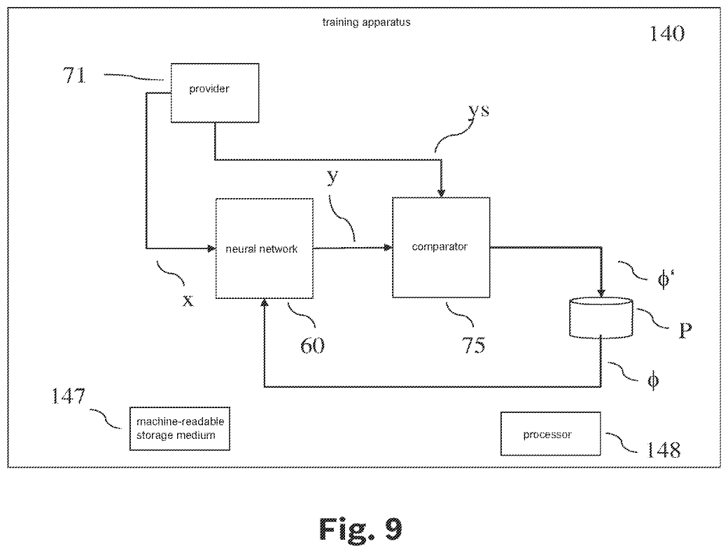

FIG. 9 shows an exemplary training apparatus 140 for training one of the drawn machine learning systems from the multigraph, in particular the neural network 60. Training apparatus 140 comprises a provider 71 that provides input variables x, such as input images, and target output variables ys, such as target classifications. The input variable x is fed to the artificial neural network 60 to be trained, which ascertains output variables y therefrom. Output variables y and target output variables ys are fed to a comparator 75 which, depending on a match between the respective output variables y and target output variables ys, ascertains new parameters ϕ′ which are transmitted to the parameter memory P and there replace parameters ϕ.

The methods executed by the training system 140 may be implemented as a computer program stored on a machine-readable storage medium 147 and executed by a processor 148.

Of course, it is not necessary to classify entire images. It is possible that a detection algorithm is used, for example, to classify image sections as objects, that these image sections are then cut out, that a new image section is generated if necessary, and that it is inserted into the associated image in place of the cut-out image section.

The term “computer” comprises any device for processing predeterminable calculation rules. These calculation rules can be in the form of software, or in the form of hardware, or also in a mixed form of software and hardware.

1-10. (canceled)

11. A computer-implemented method for creating a machine learning system, comprising the following steps:
providing a directed graph having an input node and output node connected by a plurality of edges and nodes;
randomly drawing a plurality of paths through the directed graph along drawn edges of the directed graph, wherein each respective edge is assigned a probability which characterizes with which probability the respective edge is drawn, wherein the probabilities are ascertained depending on a sequence of previously drawn edges of the respective path;
training machine learning systems corresponding to the drawn paths, wherein parameters of the machine learning system are adjusted during training so that a cost function is optimized, the parameters that are adjusted include the probabilities of the edges of the drawn paths; and
drawing a path depending on the adjusted probabilities and creating the machine learning system corresponding to the drawn path.

12. The method according to claim 11, wherein a parameterized function ascertains the probabilities of the edges depending on an order of previously drawn edges of the path, wherein the parameterization of the function is adjusted during training with respect to the cost function.

13. The method according to claim 12, wherein the previously drawn edges and/or nodes are assigned a unique coding of their order and the function ascertains the probabilities depending on the coding.

14. The method according to claim 12, wherein the function ascertains a probability distribution over possible edges, from a set of edges that can be drawn next.

15. The method of claim 12, wherein the function is an affine transformation or a neural network.

16. The method according to claim 13, wherein the function is an affine transformation or a neural network, and wherein the parameterization of the affine transformation describes a linear transformation and a shift of the unique coding, and a scaling is composed of a low-rank approximation and the scaling depending on a number of edges.

17. The method according to claim 15, wherein a plurality of functions are used and the functions are each provided by a neural network, wherein a parameterization of a plurality of layers of the neural networks are shared among all neural networks.

18. A non-transitory machine-readable storage element on which is stored a computer program including instructions for creating a machine learning system, the instructions, when executed by a computer, causing the computer to perform the following steps:
providing a directed graph having an input node and output node connected by a plurality of edges and nodes;
randomly drawing a plurality of paths through the directed graph along drawn edges of the directed graph, wherein each respective edge is assigned a probability which characterizes with which probability the respective edge is drawn, wherein the probabilities are ascertained depending on a sequence of previously drawn edges of the respective path;
training machine learning systems corresponding to the drawn paths, wherein parameters of the machine learning system are adjusted during training so that a cost function is optimized, the parameters that are adjusted include the probabilities of the edges of the drawn paths; and
drawing a path depending on the adjusted probabilities and creating the machine learning system corresponding to the drawn path.

19. An apparatus configured to create a machine learning system, the apparatus configured to:
provide a directed graph having an input node and output node connected by a plurality of edges and nodes;
randomly draw a plurality of paths through the directed graph along drawn edges of the directed graph, wherein each respective edge is assigned a probability which characterizes with which probability the respective edge is drawn, wherein the probabilities are ascertained depending on a sequence of previously drawn edges of the respective path;
train machine learning systems corresponding to the drawn paths, wherein parameters of the machine learning system are adjusted during training so that a cost function is optimized, the parameters that are adjusted include the probabilities of the edges of the drawn paths; and
draw a path depending on the adjusted probabilities and creating the machine learning system corresponding to the drawn path.
